(19) United States
(12) Patent Application Publication
(10) Pub. No.: US 2015/0193436 A1
(43) Pub. Date: Jul. 9, 2015

(54) SEARCH RESULT PROCESSING

(71) Applicant: KENT D. SLANEY, Palo Alto, CA (US)

(72) Inventor: KENT D. SLANEY, Palo Alto, CA (US)

(21) Appl. No.: 14/515,763

(22) Filed: Oct. 16, 2014

Related U.S. Application Data
(60) Provisional application No. 61/924,996, filed on Jan. 8, 2014.

(51) Int. Cl. G06F 17/30

(52) U.S. Cl. CPC G06F 17/30011; G06F 17/3053

(57) ABSTRACT

A plurality of portions of a first document in a list of documents may be compared to portions of other documents in the list of documents. The documents may be scored by determining how often portions of the first document correspond to portions of other documents in the list of documents. A consensus may be reached as to correctness of portions of documents in the list of documents by crediting a portion of a document whenever it corresponds to a portion of another document. If desired, a linguistic parser may be used to identify portions of a document. It may be desired to use word stemming or a Bayesian reference network in comparing portions of documents. Advertising and/or other extraneous portions of the documents may be deleted. The documents may be ranked relative to each other as a function of how often portions of each document correspond to portions of other documents.

### RELATED APPLICATIONS

This application claims the benefit of the earlier filing date of U.S. Provisional Patent Application No. 61/924,996 filed Jan. 8, 2014. The disclosure in the aforementioned U.S. Provisional Patent Application No. 61/924,996 is hereby incorporated herein in its entirety by this reference thereto.

### BACKGROUND OF THE INVENTION

The present invention relates to a search result processing method and apparatus.

An ordered list of documents, which are related to the subject matter of a user query, is received from an external search engine. Known external search engines, like Google and Bing, retrieve a list of documents which have been determined to be likely to be relevant to the subject matter of a user query. However, these known search engines do not provide an indication of which one document in the collection of documents has the most support, in terms of general agreement, that is, consensus, with other documents in the collection of documents.

A known fact checking system is disclosed in the United States Patent Application Publication 2012/0317593 A1 published on Dec. 13, 2012. However, this known fact checking system does not compare a portion of one document in a list of documents with portions of other documents in the list of documents. Another known document collection system includes a collection index having single and multiple word phrases as indexed terms occurring in the collection of documents. This known document collection system is disclosed in U.S. Pat. No. 6,070,158.

### SUMMARY OF THE INVENTION

The present invention relates to a search result processing method and apparatus which receives a list of documents which have previously been determined to be relevant to the subject matter of a user query. Portions of one document in a list of documents are compared to portions of other documents in the list of documents. A determination may be made as to how often portions of documents in the list of documents correspond to portions of the one document. Portions of the one document may be scored by determining how often portions of the one document correspond to portions of other documents in the list of documents. A consensus may be reached as to correctness of portions of the documents in the list of documents by crediting a portion of a document whenever it corresponds to a portion of another document. A determination may be made that portions of documents receiving the most credit are more likely to be correct than portions of documents receiving less credit.

The present invention includes as plurality of features. These features may be used together as disclosed herein. Alternatively, these features may be used separately and/or in combination with known prior art features.

### BRIEF DESCRIPTION OF THE DRAWINGS

The foregoing and other features of the present invention will become more apparent upon a consideration of the following description taken in connection with the accompanying drawing wherein:

FIG. 1 is a schematic illustration depicting the relationship between an external search engine and apparatus and steps of a method used to process the results of operation of the external search engine.

### DESCRIPTION OF SPECIFIC PREFERRED EMBODIMENTS OF THE INVENTION

### General Description

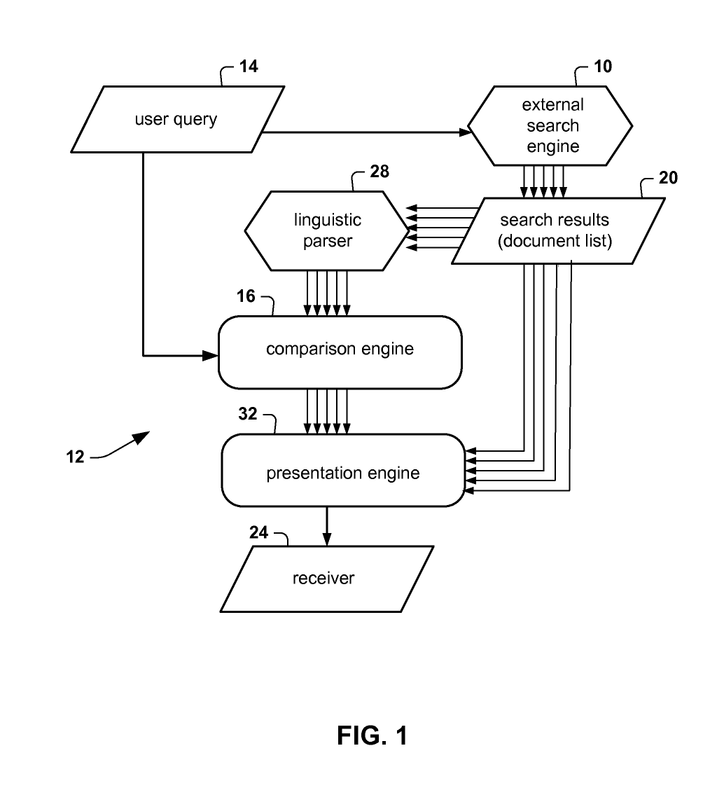

The relationship between a known external search engine 10 and other apparatus 12 used to process the results of the search engine is illustrated in FIG. 1. A user query, indicated schematically at 14 in FIG. 1, is transmitted to the external search engine 10. The external search engine 10 is a computer which may have any desired known construction. In addition to being transmitted to the external search engine 10, the query is transmitted to a comparison engine 16 in the apparatus 12. The comparison engine 16 is a computer having a known construction.

The external search engine 10 is operated in a known manner to search databases and obtain search results which relates to the user query 14. The external search engine 10 may be operated so as to provide search results in the form of a list of documents which have been indicated schematically at 20 in FIG. 1. Each document in the list of documents has been determined by the external search engine 10 to be relevant to the subject matter of the user query 14. The external search engine 10 ranks the documents in the search results 20 as a function of the relevance of the content of each of the documents. The external search engine 10 may also provide a summary of the content of each one of the documents in the search results 20. The document rankings and/or summaries provided by the external search engine 10 are based on the content of each individual document and are not a function of the content of all the documents.

The search results 20 (list of documents) are transmitted from the external search engine 10 to the apparatus 12. The apparatus 12 processes the search results 20 and transmits results of this processing to a receiver 24. The result transmitted from the apparatus 12 to the receiver 24 may take any one of many different forms.

As an example, the results transmitted from the apparatus 12 to the receiver 24 may set forth the most central sentences in each document of the search results 20 as a query-responsive summary of the document. If desired, the order or rank in which the documents in the search results 20 are presented to the receiver 24 may be changed from the original order or rank provided by the search engine 10 as a function of how often portions of one document correspond to portions of other documents. Alternatively, the re-ranking or ordering of which are presented to receiver 24 may be performed as a function of both the original ranking of the documents and as a function of how often portions of one document correspond to portions of other documents. If desired, a summary of all of the documents in the search result may be prepared. This summary may set forth most central sentences of some or all of the documents in the search results. Repetition may be avoided using cluster analysis. The results transmitted from the apparatus 12 to the receiver 24 may indicate how frequently a portion of a document corresponds to the user query 14.

If desired, the search result presented to the receiver 24 may include a summary which indicates which document or documents have the most support in terms of correctness of portions of the document in comparison to portions of other documents set forth in the search result 20. Instead or in addition, a summary may be provided of the entire corpus of the search results 20. This may be a summary which is a function of the content of a plurality of the documents in the search results 20. Portions of documents having the most support in terms of correctness may be used to form the summary of the documents in the search result presented to the receiver 24.

A consensus as to the correctness of portions of the documents in the search results 20 may be presented to the receiver 24. The consensus as to the correctness of portions of the documents in the search results 20 may be reached by crediting portions of a document whenever it corresponds to a portion of another document and determining that portions of documents receiving the most credit are the most likely to be correct.

It is contemplated that the results transmitted from the apparatus 12 to the receiver 24 may be different for the same query 14 depending upon the desires of an individual utilizing the results transmitted to the receiver 24. For example, the results transmitted to the receiver 24 may be a summary of the entire corpus (body) of the search results 20. Alternatively, the output transmitted to the receiver 24 may be a summary of each of the documents. In either case, the correctness of each one of the documents may be scored by determining how often portions of other documents in the search results 20 correspond to portions of the one document. The documents may be ranked as a function of how often portions of each document in the search results 20 correspond to portions of other documents in the search results.

### DESCRIPTION OF SPECIFIC EMBODIMENTS

The search results 20 are transmitted from the external search engine 10 to a linguistic parser 28 in the apparatus 12. The linguistic parser 28 works out grammatical structure of the text of each of the documents contained in the search results 20. In doing this, the linguistic parser locates and accounts for words that negate, such as not, no, nor, neither, none, never, etc. The linguistic parser 28 has a known construction, such as the Stanford Parser or the Python library “NLTK”.

The linguistic parser 28 may be utilized to replace pronouns with their antecedents and may be utilized to segment each of the documents into portions, such as paragraphs, sentences, and/or concepts. The linguistic parser 28 and comparison engine 16 may be utilized to keep all of the sentences, paragraphs, concepts, or other portions that are parsed out of a document. Alternatively, the linguistic parser 28 and comparison engine 16 may select only sentences, paragraphs, concepts, or other portions that show sufficient overlap with a users original search query 14.

A determination of the overlap of portions of a document to an original search query 14 may be accomplished using any of a variety of approaches. Perhaps the simplest approach may be to require exact word matching to consider the two parts as overlapping. It is believed that this approach may have the advantage of simplicity. However, this approach tends to underestimate the overlap of portions of a document due to changes in plural terms, or in conjugation, or use of synonyms.

An alternative approach to determining overlap in conjunction with parsing a document is to use word stemming before looking for word matching. For example, Porter stemming software may be utilized as a library in Python. This approach helps avoid problems with conjugations and plural terms. However this approach does not address synonyms.

Still another approach is to handle the problem of synonyms by moving away from words to concepts. This may be done using a Bayesian inference network. One known network is provided by Google's Probabilistic Hierarchical Inference Learner (PHIL).

When PHIL or another network is used, each sentence, paragraph, concept, or other portion of a document may be processed as a unit to keep track of which clusters PHIL places the sentence or other portion into. This may be done after pronouns have been removed. Once this has been done, the overlap of a sentence, paragraph, concept, or other portion of a document with the original user query 14 can be measured. This may, for example, be accomplished using a cosine distance between selected PHIL clusters that describe each sentence, paragraph, concept, or other portion of a document.

It is believed that it may be desirable to eliminate portions of the document which are considered to be unessential. Thus, paid advertisements, references to other sites or services, indexes, and/or summaries may be eliminated as a portion to be considered. This can be done by parsing the hypertext markup language (HTML) and/or the cascading style sheets (CSS). This parsing may be done using heuristic rules to separate the nonessential material from the main body of a document. In addition, it may be desired to eliminate comments and/or related links to other articles.

This enables the linguistic parser 28 to eliminate extraneous material contained in a document before the comparison engine 16 determines how often portions of one document in the search results 20 correspond to portions of other documents in the search result 20 and/or before determining which portions of one document in the search results 20 is more likely to be correct than portions of other documents in the search results 20. Thus extraneous material, that is, nonessential material, is eliminated from the search results 20 before the linguistic parser 28 processes the search results 20. However, it may be preferred to eliminate nonessential materials before the search results 20 are processed by the comparison engine 16. The nonessential material may be considered by the comparison engine 16 if desired.

After the search results 20 has been processed by the linguistic parser 28, the comparison engine 16 compares each document in the search results 20 to each of the other documents in the search results. The comparison engine 16 may be a specialized processor which contains software which performs specific functions to enable the comparison engine to compare each one of the documents in the search results 20 to the other documents in the search results. The comparison engine 16 may compare the entirety of one document to the entirety of the other documents in the search result 20. Alternatively, the comparison engine 16 may compare one or more selected portions of one document in the search results 20 to one or more portions of the other documents in the search results 20. The comparison engine 16 considers the effect of words which negate, such as not, no, nor, neither, none, never, etc.

Regardless of whether the comparison engine 16 is utilized to compare the entirety of one document in the search results to the entirety of other documents in the search results 20 or to compare one or more portions of each search document in the search results to one or more portions of other documents in the search results, the comparison engine compares each document in the search results 20 to the other documents in the search results. This enables the comparison engine 16 to get a measure of consensus or centrality of each document and/or one or more portions of each document which has been located by the external search engine 10. The portions of the documents and/or the entire documents may be used to obtain a consensus from the documents. When a measure of consensus has been obtained across the corpus of the documents in the search results 20, portions determined by the linguistic parser 28 may be used in various ways to obtain different presentation methods. A measure can be obtained as to how central a statement made by any one of the portions of one of the documents in the search results 20 is to the portions of the full corpus of the documents in the search results 20.

To improve matching between closely-related (but not identical) portions of one document to portions of the other documents, without allowing too many spurious matches, a measure may be obtained as to how well each selected portion of one document matches portions in another document. In comparing one portion of a document with a portion of another document, the words (or stems or clusters) from the portion of the one document are located in each of the other documents in the search result 20. A determination is then made as to where each unit (words/stems/cluster) occurred in the portion of the one document and where it occurred in a portion of the other document to which it is being compared. The difference between where a unit (word/stem/cluster) occurred in the one document and where it occurs in the document to which it is being compared provides an indicator of where the portion of the one document would have occurred in the other document.

It is believed that some predetermined amount of separation will be allowed between the units (word/stem/cluster) of two documents which are being compared. For example, it may be desired to allow at most two additional or missing units or units in the portions of the document to which the one document is being compared. The result of comparing portions of a first document to portions of a second document may be scored or credited if there are at most two additional units or missing units in the portion of the second document. This will allow units or words in the second document to be spaced from neighboring units or words by more or less than in the first document and still allow the units of a second document to be scored or credited as corresponding to units of the first document.

Matching between closely-related (but not identical) portions of one document and another document may be facilitated by using stop word removal and by weighting a score or credit as a function of inverse frequency of occurrence in a general usage. Stop word or phrase removal is a known technique to remove words that occur so frequently throughout language as to have little use in determining a topic being discussed. Most common examples of stop words are “the”, “a”, “in”, “very”, and so on. In addition, words are phrases that are for transition or emphasis may be treated as stop words. Thus, “in addition”, “on the other hand”, and so on may be treated as stop words and removed. A stop word list may be utilized. There are a large number of stop-word lists that are pre-computed, including lists in Python's NLTK.

As a function of how often and well portions of one document correspond to portions of another document, frequency weighting may be used for units (words/stems/clusters) as a function of spacing between units. The closer the spacing between the units (words/stems/clusters) to the facing unit in the portion to which a document is being compared, the greater the weight, that is the score or credit, which would be given to a determination that has been made. Once a measure of how closely a selected unit is being repeated within a selected portion of a document to which another document is being compared, a determination can be made as to the extent of the consensus or agreement between the documents. If there is a relatively high degree of consensus or agreement between portions of a document being compared, the portions of the document being compared will be given a credit or score that is greater than if there was a lesser amount of consensus or agreement between the portions of the two documents.

Once a determination has been made of how closely a selected portion of a first document is being repeated within a second document, a consensus or “central” measure can be made for that portion of the second document. This may be done by counting how many times the portion of the first document can be matched with the portion of the second document with a measure which was more than a fixed threshold. Alternatively, the weight (or fraction account) of a portion of a second document may be increased for matches that are closer than the original threshold by how much more support they have than is needed to simply pass the threshold measure. This may be done with a single portion of the first document and then across all the portions in the document and across all the documents in the corpus of the search results 20.

Once the comparison engine 16 has compared a plurality of portions of each document in the search results 20 to a plurality of portions in each of the other documents in the search result, a determination is made as to consensus between the documents. This consensus is a function of how often portions of one document in the list of documents correspond to portions of other documents in the list of documents. The portions of each of the documents is scored as a function of how often portions of each document corresponds to portions of other documents in the list of documents.

Scoring may be accomplished by crediting a portion of a document whenever it corresponds to a portion of another document. Totaling the number of credits given to the portions of each of the documents in the search results 20 results in a scoring of the document. In scoring the documents in the search results 20, the comparison engine 16 accounts for words which negate.

After the portions of each of the documents in the search results 20 have been compared to the portions of the other documents in the search results, the results of this comparison is utilized to score the portions of each document by crediting a portion of the document whenever it corresponds to a portion of another document. This scoring provides an indication of the correctness of the portions of the documents. The higher the score of the portions of a document, the greater is the agreement of the portions of a document with portions of other documents in the search results and the greater is the likelihood that the portions of a document are correct.

The results of the comparisons made by the comparison engine 16 is transmitted from the comparison engine to a presentation engine 32 in the apparatus 12. Depending upon the desires of an individual utilizing the apparatus 12 to process the search results 20, the presentation engine 30 may be utilized to provide a desired output to the receiver 24. For example, the output of the presentation engine 32 may be utilized to create a summary of the search results 20. The summary provided for the receiver 24 from the full list of documents may be used as the summary of the topic of the users query 14. As another example, the output of the presentation engine 32 may be utilized to indicate a consensus as to the correctness of portions of each of the documents in the search results 20. If desired a combination of the summary and consensus as to the correctness of portions of the documents may be combined or may both be provided to the receiver 24 by the presentation engine 32.

If a summary of the search results 20 is to be presented to a receiver 24, the scores obtained by crediting a portion of a document when it corresponds to portions of other documents may be used to determine which portions of the documents are to be included in the summary. The portion of a document having the greatest score will have the greatest consensus with other documents in the search results 20. In addition, the portions of a document having the greatest score will have the greatest likelihood of being correct. In addition to containing the portion of a document having the greatest score, the summary may includes portions of documents having scores which progressively diminish from the greatest score.

The search results 20 may rank, that is, determine a degree of importance of each of the various documents, as a function of how relevant the external search engine 10 determines each of the documents to be based on only the content of each document. Thus, the external search engine 10 originally ranks each one of the documents in the search results as a function of the content of the one document. The search engine 10 does not rank the documents in the search results 20 as a function of the content of other documents in the search results and/or how often portions of one document corresponds to, that is, agrees with, portions of other documents in the search results 20.

The search results transmitted to the receiver 24 by the presentation engine 32 may rank, that is, determine the relative importance of each of the various documents in the search results 20, as a function of only the scores obtained by crediting a portion of a document when it corresponds to portions of other documents in the search results 20. This would result in the document having the highest score as a result of agreeing with the greatest number of portions of other documents in the search result 20 having the highest rank. Similarly, the document having the lowest score as a result of agreeing with the least number of portions of other documents in the search result would have the lowest rank.

If desired, the search results transmitted to the receiver 24 by the presentation engine 32 may rank the documents in the search results 20 as a function of both the original ranking of the documents by the search engine 10 and the scores obtained by crediting a portion of a document when it corresponds to portions of other documents. For example, the ranking of a document may be allowed to rise or fall by only a predetermined number of levels from that documents original ranking by the external search engine 10. Therefore, the original rank of one document by the search engine 10 could only increase by the predetermined number of levels relative to the ranks of the other documents as a result of a high degree of correspondence to portions of the one document to portions of the other document. Similarly, the original rank of one document by the search engine 10 could only decrease by the predetermined number of levels relative to the ranks of the other documents as a result of a low degree of correspondence to portions of the one document to portions of the other documents.

In addition to ranking the documents in the search results 20 relative to each other, the search results transmitted from the presentation engine 32 to the receiver 24 may include a summary of the contents of the documents in the search results 20 as function of the content of a plurality of the documents in the search result 20 (list of documents). This summary may set forth the portions of documents which have the most support in terms of correctness as determined by agreement with portions of the other documents in the search result 20. Although the summary may be formed by portions of a single document, it is believed that the summary will probably be formed by portions of a plurality of documents in the search results 20.

### EXAMPLES

As one example, a search query 14 may be “Steve Jobs apple computer”. The comparison engine 16 may utilize the search query 14 as a loose template and look for places in the documents in the list 20 of documents which have that same general template. In doing this, the comparison engine 16 may measure how well portions of each document in the search results 20 matches the search query 14. In doing this, words (or stems, or clusters) in portions of a document in the search results 20 are compared to the search query 14. Some separation, for example two additional or missing words, may be allowed between words in the portions of the documents in the search results 20 being searched by the comparison engine 16. By allowing only a predetermined separation between words in the document being searched, a portion of a document relating to job prospects covering both agriculture and internet technology in spaced apart locations in a document would not be considered. However, a portion of the document mentioning Steve Jobs and Apple computer in closely adjacent locations would be considered.

The scoring function measures of how well the words “apple” and “computer” match the query 14 by weighting them differently, for scoring purposes, when they are closely adjacent to each other than when they are separated. This would result in “apple” and “computer” being given a greater score when they are no words between “apple” and “computer” than when they are one or more words between “apple” and “computer” in the portion of a document being searched.

As another example, a search query 14 may be “civil war”. The comparison engine 16 may be used to obtain a measure of correctness of a portion of one document by determining how many documents agreed with the one document. For example, the one or first document may state that “Roosevelt was president during the civil war”. If none of the documents in the search results 14 contained a statement similar to the one in the one or first document, the statement in the one or first document would be considered to have a very low likelihood of being correct.

Similarly, the one or first document may state that “Lincoln was president during the civil war”. If the other documents in the search results 14 contained a statement similar to the one in the one or first document, the statement in the one or first document would be considered to have a very high likelihood of being correct.

Having described the invention, the following is claimed:

1. A search result processing method which includes the following steps:
receiving a list of documents, each document in the list of documents having previously been determined to be likely to be relevant to the subject matter of a user query;
determining a plurality of portions in each of the documents in the list of documents;
comparing a plurality of portions of a first document in the list of documents to portions of documents in the list of documents;
determining how often portions of the first document in the list of documents correspond to portions of other documents in the list of documents; and
scoring portions of the first document by determining how often portions of the first document correspond to portions of other documents in the list of documents.

2. A method as set forth in claim 1 wherein said step of determining how often portions of the first document in the list of documents correspond to portions of other documents in the list of documents includes determining how often and well portions of documents in the list of documents correspond to portions of the first document and said step of scoring portions of the first document includes crediting portions of the first document as a function of how often and well portions of documents in the list of documents correspond to portions of the first document.

3. A method as set forth in claim 1 further including the steps of comparing a plurality of portions of each of the documents other than the first document to portions of documents in the list of documents, determining how often portions of each of the document other than the first document correspond to portions of documents in the list of documents, and scoring portions of each of the documents other than the first document by determining how often portions of documents other than the first document correspond to portions of documents in the list of documents.

4. A method as set forth in claim 3 further including the step of creating a summary of the documents in the list of documents as a function of the scoring of portions of each of the documents in the list of document.

5. A method as set forth in claim 3 wherein said step of determining how often portions of each of the documents other than the first document correspond to portions of documents in the list of documents includes determining how often and well portions of each of the documents in the list of documents other than the first document correspond to portions of documents in the list of documents, said step of scoring portions of each of the documents other than the first document includes crediting portions of each of the documents other than the first document in the list of documents as a function of how often and well portions of each of the documents in the list of documents correspond to portions of documents in the list of documents.

6. A method as set forth in claim 1 further including the step of ranking the documents in the list of documents relative to each other as a function of how often portions of each document correspond to portions of other documents in the list of documents.

7. A method as set forth in claim 1 wherein said step of receiving a list of documents includes receiving a list of documents each one of which has been initially ranked relative to other documents in the list of documents as function of the relevance of the content of the one document to the user query, said method further includes reranking the documents relative to each other as a function of how often portions of each document correspond to portions of other documents in the list of documents.

8. A method as set forth in claim 1 wherein said step of receiving a list of documents includes receiving a list of documents each one of which has been initially ranked relative to other documents in the list of documents as a function of the relevance of the content of the one document to the user query, said method further includes reranking the documents relative to each other as a function of both their initial ranking and how often portions of each document correspond to portions of other documents in the list of documents.

9. A method as set of forth in claim 1 further including the step of creating a summary of the documents in the list of documents, said step of creating a summary of the documents in the list of documents includes selecting a portion of one document in the list of documents and selecting portions of other documents in the list of documents which are different than the selected portion of the one document.

10. A method as set forth in claim 1 wherein said step of determining a plurality of portions in each of the documents in the list of documents includes using a linguistic parser to identify sentences in each of the documents in the list of documents.

11. A method as set forth in claim 1 wherein said step of determining a plurality of portions in each of the documents in the list of documents includes using a linguistic parser to identify paragraphs in each of the documents in the list of documents.

12. A method as set forth in claim 1 wherein said step of determining a plurality of portions in each of the documents in the list of documents includes using a linguistic parser to identify concepts in each of the documents in the list of documents.

13. A method as set forth in claim 1 further including the step of creating a summary of the contents of the list document in the list of documents as a function of content of portions of a plurality of the documents in the list for which the summary is being created.

14. A method as set forth in claim 1 further including repeating said step of comparing one portion of a first document in the list of documents to the plurality of portions in each of the documents in the list of documents for each portion of the first document.

15. A method as set forth in claim 1 further including the step of separating advertising sections from remaining portions of each document in the list of documents.

16. A method as set forth in claim 15 wherein said step of separating advertising sections from remaining portions of each document includes using heuristic rules.

17. A method as set forth in claim 15 wherein said step of separating advertising sections from remaining portions of each document including parsing the hyper text markup language for each document.

18. A method as set forth in claim 1 wherein said step of comparing one portion of a first document in the list documents to the plurality of portions in each of the documents in the list of documents includes using word matching techniques to determine when the one portion of the first document corresponds to a portion of a document.

19. A method as set forth in claim 1 wherein said step of comparing one portion of a first document in the list of documents to the plurality of portions in each of the documents in the list of documents includes using word stemming techniques to reduce words in the plurality of portions in each of the documents in the list of documents to base forms, said step of comparing one portion of a first document in the list of documents to the plurality of portions in each of the documents in the list of documents includes comparing base forms of words in the one portion of the first document in the list of documents to base forms of words in the plurality of portions in each of the documents in the list of documents.

20. A method as set forth in claim 1 further including the step of creating a summary of the documents as a function of distinctions between portions of the first document and portions of other documents in the list of documents.

21. A method as set forth in claim 1 further including determining words which negate in portions of any of the documents in the list of documents and considering the effect of any words which negate in performing said steps of comparing a plurality of portions of the first document to portions of other documents in the list of documents and in performing said step of determining how often portions of the first document in the list of documents correspond to portion of other documents in the list of documents.

22. A search result processing method which includes the following steps:
receiving a list of documents, each document in the list of documents having previously been determined to be likely to be relevant to the subject matter of a user query;
determining a plurality of portions in each of the documents in the list of documents;
comparing portions in each of the documents in the list of documents to each other; and
reaching a consensus as to correctness of portions of the documents in the list of documents by crediting a portion of a document whenever it corresponds to a portion of another document and determining that portions of documents receiving the most credit are more likely to be correct than portions of documents receiving less credit.

23. A method as set forth in claim 22 wherein said step of reaching a consensus as to correctness of portions of documents by crediting a portion of a document whenever it corresponds to a portion of another document includes determining how often and well a portion of one document corresponds to a portion of another document.

24. A method as set forth in claim 22 wherein said step of comparing portions in each of the documents to each other includes comparing all of the portions of each one of the documents in the list of documents to all of the portions of the other documents in the list of documents.

25. A method as set forth in claim 22 wherein said step of determining a plurality of portions in each of the documents in the list of documents includes using a linguistic parser to locate portions in each of the documents.

26. A method as set forth in claim 22 further including creating a summary of each document in the list of documents as a function of the content of the portions of the documents for which the summary is being created.

27. A method as set forth in claim 22 wherein said step of determining a plurality of portions of each of the documents in the list of documents includes determining a plurality of portions which are free of advertising material in each of the documents.

28. A method as set in claim 22 further including the step of separating extraneous material from the main body of each document in the list of documents prior to performing said step of determining a plurality of portions in each of the documents.
